(19) United States
(12) Patent Application Publication
(10) Pub. No.: US 2006/0116435 A1
(43) Pub. Date: Jun. 1, 2006

(54) High strength polyurethane foam

(76) Inventor: Tyler L. Housel, Lansdale, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/291,122

(22) Filed: Nov. 30, 2005

Related U.S. Application Data
(60) Provisional application No. 60/632,096, filed on Dec. 1, 2004.

(51) Int. Cl. C08G 18/00

(52) U.S. Cl. 521/174

(57) ABSTRACT

A low density polyurethane foam is provided with improved strength characteristic, prepared by a process comprising reacting, under foam forming conditions, a polyester polyol having a number average molecular weight of about 1000 and about 4000, an organic polyisocyanate, a blowing agent, and at least one catalyst.

### CROSS REFERENCE TO RELATED PATENT APPLICATIONS

The present application claims the benefit of U.S. Provisional Patent Application 60/632,096, filed Dec. 1, 2004, the entirety of which is hereby incorporated by reference herein.

### FIELD OF INVENTION

The present invention relates generally to the field of polyurethane foams, and specifically to low density polyurethane foam having exceptional tensile strength, tear strength and elongation characteristics.

### BACKGROUND OF INVENTION

Polyurethane foam is formed from a reaction of a polyisocyanate and a polyol in the presence of blowing agents to provide gas that fills the cells. Approximately 80-99% of a typical polyurethane foam formulation consists of polyisocyanate, polyol and a blowing agent (typically water). These and other components can have a significant impact on the strength properties of the foam because they form the polymer chains that give structure to the foam. In addition, these and other components can have a significant impact on the density, elongation and other characteristics of the foam.

Generally, polyurethane foam formulation requires silicone or organic surfactants to stabilize the foam and catalysts to control the rates of the various simultaneous reactions. Other additives may also be added to improve aesthetic or functional properties of the finished foam. These can include items such as colorants, crosslinkers, plasticizers, fillers or flame retardants to impart specific properties.

Polymeric polyol is usually the largest component by weight in a polyurethane formulation, so it is expected to significantly affect the strength of the foam. Polymeric polyols are normally 1000-6000 molecular weight polymers that average between 2 and 4 reactive hydroxyl groups per molecule. Commercial polymeric polyols are generally based on repeating ester or ether units. These are commonly known as polyester polyols and polyether polyols. Polymeric polyols based on other repeat structures have been introduced but have not achieved a wide market penetration in polyurethane foams.

The vast majority of polyester polyols used in the slabstock foam industry are made from diethylene glycol and adipic acid with additional functionality being imparted from small levels of glycerin, trimethylol propane or other monomeric polyols. Typical polyester polyols for slabstock foam have a hydroxyl value between 50 and 60 and hydroxyl functionality between 2.4 and 3.0. It is generally believed that it is difficult to produce low-density slabstock polyurethane foam with polyester functionalities outside that range.

Polyether polyols are generally copolymerized from ethylene oxide and propylene oxide using a monomeric di- or polyol as an initiator. These are available in a wider variety of crosslink densities and molecular weights than polyester polyols. Most polyether based foams are used in cushioning applications such as seat cushions where exceptional tensile strength is not required.

Generally, polyurethanes are made with reactive polyisocyanates. In the foam industry, the majority are aromatic polyisocyanates, broadly classified as toluene diisocyanate (TDI) types and methylene diphenyl diisocyanate (MDI) types. In slabstock foams, TDI is usually the isocyanate of choice. There are two isomers of TDI. The 2,6 isomer has two isocyanate groups ortho to the methyl group on a toluene ring. The 2,4 isomer has an isocyanate ortho and another para to the methyl group. Processes for manufacturing TDI always make a combination of the 2,4 and 2,6 isomers while little isocyanate is formed at the meta site. Therefore, other isomers (2,3 TDI, 3,4 TDI and 3,5 TDI) are present in insignificant quantities. Two types of TDI are typically manufactured for foam use. TDI-80 has 80% of the 2,4 isomer and TDI-65 has only 65% of the 2,4 isomer. In both cases, the remainder is the 2,6 isomer.

In addition, a blowing agent (typically water) is added to essentially all polyurethane foam formulations. Water can react with isocyanate groups to produce carbon dioxide. This CO₂ is the gas that fills the cells and foams the reacting mixture. Some grades of foam contain additional blowing agents that volatilize as the reaction exotherm heats the foam. These are typically low boiling liquids such as fluorocarbons, chlorofluorocarbons, hydrofluorocarbons, hydrochlorocarbons, acetone, cyclopentane, pentane and the like.

Once the liquid ingredients are mixed together, all reactions must proceed at the correct rates. In the foaming mixture of one embodiment of the present invention, both polyol and water are vying to react with the available isocyanate groups. When the isocyanate reacts with water it produces the carbon dioxide gas that fills the cells. This is called the blowing reaction. When the isocyanate reacts with the hydroxyl groups from the polyol, it increases the average molecular weight, leading to higher viscosity, gelation and finally polymer strength. This is called the gel reaction. Since these reactions occur simultaneously, the rates must also be controlled relative to each other. For example, if the blow reaction goes too fast, the gas will bubble out of the foam before it is elastic enough to expand. In this extreme case, the foam bun will collapse on itself. Catalysts are added to the formulation to control each of these reactions. Normally tin or other metal catalysts primarily promote the gel reaction. Amine catalysts can promote either the gel or blow reaction depending on the specific chemical structure. Also, the temperature of the system increases during the reaction, and different catalysts may be more temperature sensitive. Because of the complexity of the foam system, several different catalysts are often precisely added to a formulation to give the appropriate reaction rates from mixing through cure.

During the manufacturing process, liquid reactants are mixed together and bubbles form in the liquid. As the reaction proceeds, the bubbles grow and the molecular weight of the polymer increases, so that it eventually becomes a matrix of polymer surrounding cavities filled with gas. The final foam is stabilized by the crosslinked polymer structure, but while the reactants are still liquid, a surfactant can be added to stabilize the bubbles and prevent them from coalescing. The surfactant can play a critical role in forming the nucleation sites that will become the bubbles. All other additives to a foam formulation must be chosen so that they do not interfere with the nucleation and stabilization roles of the surfactant.

There are two types of surfactant commonly used to make polyurethane foams. These are broadly termed silicone types and organic types, depending on whether the chemical structure is based on polysiloxanes. Both types are usually blends of subcomponents that have various emulsification and cell stabilization functions. These emulsification and stabilization properties must work with the specific polymeric polyol, polyisocyanate and additives in the foam formulation. In practice, many different surfactant products are necessary because of the wide variety of foams produced.

Many types of foam are intended for specific uses that require special properties. To attain different properties, additives are often used to modify an existing formulation. Examples of these additives would be flame retardants, colorants, crosslinkers, antimicrobials, fillers, light stabilizers, antioxidants and the like.

Low density foams are generally limited to applications where they are used as cushioning or padding material. Typical foams cannot be used in an elastic or semi-elastic capacity because they lack characteristics such as the tear and tensile strength necessary for prolonged and repeated use. In addition, typical low density foams suffer from an increased risk of tearing during processing.

Various attempts have been made to solve these deficiencies. For example, low density foam has been bonded to spandex fibers to increase the strength characteristics. In addition, others have tried to laminate the foam to fabric, used higher density foams, or used a non-foam material entirely. With a more complex system such as that previously described, however, more components are needed to support the foam and prevent the foam from breaking. As important, as the foam density is increased, the foam becomes heavier and more expensive to process and handle.

Still others have attempted to develop low density foams with good strength characteristics. One such foam is shown and described in U.S. Pat. No. 3,988,269 to Puig et al. (“Puig”). Puig describes using chlorine-containing, methylene bridged diaryl diisocyanates to produce a polyurethane foam with high strength and load bearing properties. As disclosed in Puig, three examples are listed with densities from 2.4 to 3.1 pcf. The highest tensile strength achieved was only 17.8 psi with a maximum tear strength of 3.7 pli. (As an aside, to convert from metric units, we use conversions of 1 kg/cm²=14.2 psi, and 1 KPa=0.145 psi, and 1 kg/m³=0.001 g/cm³=0.062 pcf. Note that psi stands for pounds per square inch (lb/in²) and pcf stands for pounds per cubic foot (lb/ft³))

Another such attempt is U.S. Pat. No. 5,700,847 to Thompson et al. (“Thompson”). Thompson describes water blown foams having good tensile strength and elongation made from prepolymers of polyether polyols with low unsaturation. The claimed formulations produce foam with a density of 1 to 4 pcf. From the examples, a 2.3 pcf sample gave only a 20 psi tensile strength, 2.2 pli tear strength and elongation of 178%.

Thus, there is a need for a low density polyurethane foam with improved tensile strength, tear strength and elongation characteristics.

### SUMMARY OF INVENTION

It is therefore an object of the present invention to provide a polyurethane foam.

Another object of the present invention is to provide a low density polyurethane foam having exceptional tensile strength, tear strength and elongation characteristics.

Another object of the present invention is to provide a low density polyurethane foam having a tensile strength of at least about 30 pounds per square inch.

Yet another object of the present invention is to provide a low density polyurethane foam having a tensile strength of between about 35 and about 50 pounds per square inch.

Another object of the present invention is to provide a low density polyurethane foam having a tear strength of at least about 5 pounds per linear inch.

Yet another object of the present invention is to provide a low density polyurethane foam having a tear strength of between about 5 and about 9 pounds per linear inch.

Another object of the present invention is to provide a low density polyurethane foam, wherein the foam is capable of elongating to at least about 300%.

Yet, another object of the present invention is to provide a low density polyurethane foam, wherein the foam is capable of elongating to at least about 350%.

These and other objects are met by the present invention, which in one aspect, is a low density, high strength polyurethane foam prepared by a process comprising reacting, under foam forming conditions, a polyester polyol having a number average molecular weight of about 1000 and about 4000, an organic polyisocyanate, a blowing agent, and at least one catalyst.

In some embodiments, the polyester polyol has an equivalent weight of between about 500 and about 2000, has a hydroxyl functionality of between about 2 and about 3 and has a hydroxyl value between about 30 and about 110 mg KOH/g. Preferably, the polyester polyol is prepared from reacting a mixture, at least about 90% by weight of which is a combination of adipic acid and at least one linear diol.

In one embodiment, the organic polyisocyanate is toluene diisocyanate. In a further embodiment, the blowing agent comprises water and the water is present in an amount between about 2 and about 5 parts per hundred polyol by weight. In yet a further embodiment, the catalyst comprises a tertiary amine.

In another aspect, the invention is a low density, high strength polyurethane foam prepared by a process comprising reacting, under foam forming conditions, a polyester polyol having a number average molecular weight of about 1000 and about 4000, having an equivalent weight between about 500 and about 2000, having a hydroxyl functionality of between about 2 and about 3 and a hydroxyl value between about 30 and about 110 mg KOH/g, wherein the polyester polyol prepared from a mixture comprising at least about 90% by weight adipic acid and at least one linear diol; an organic polyisocyanate; a surfactant; a blowing agent; and at least one catalyst, wherein the foam has a density of about 1 to about 4 pounds per cubic foot, has a tensile strength between about 35 and about 50 pounds per square inch, has a tear strength between about 5 to about 9 pounds per linear inch and is capable of elongation to at least about 300%.

In yet another aspect, the invention is a method for preparing low density, high strength polyurethane foam comprising the step of reacting at least one polyester polyol having a number average molecular weight of about 1000 and about 4000, having a hydroxyl functionality of between about 2 and about 3 and a hydroxyl value between about 30 and about 110 mg KOH/g, an organic polyisocyanate, a blowing agent, and at least one catalyst.

### DETAILED DESCRIPTION OF THE INVENTION

The current invention provides for a low density polyurethane foam that has outstanding tensile, tear and elongation characteristics.

To quantify the improvements in strength and elongation properties, the following test methods were employed: (1) Tensile Strength: Tensile strength gives the amount of force needed to break a foam specimen. The standard test method for tensile strength is ASTM D3574-test E. (2) Elongation: Elongation is the percentage increase in the length of a foam specimen before it ultimately ruptures. Elongation is measured along with tensile strength using ASTM D3574-test E. (3) Tear strength: Tear strength is the amount of force required to tear a foam sample apart by pulling the foam apart across a cut. Tear strength is covered under ASTM D3574-test F.

The present invention comprises a low density, high strength, and high elongation polyester-based polyurethane foam and the formula used to make the foam. A main component of the high strength foam is polymeric polyol. In one embodiment, the polymeric polyol is a linear polymeric polyol. In one preferred embodiment, the polymeric polyol is a polyester polyol. To impart outstanding strength, the polyester polyol in one embodiment can have a number average molecular weight between about 1000 and about 4000. The polyester polyol in another embodiment can have an equivalent weight between about 500 and about 2000. In yet another embodiment, the polyester hydroxyl value can be between about 28 and about 110 and the hydroxyl functionality can be between about 1.5 and about 3, preferably between about 1.9 and about 2.2. In a preferred embodiment, the polyester polyol can have a number average molecular weight between about 1000 and about 4000, an equivalent weight between about 500 and about 2000, the polyester hydroxyl value being between about 28 and about 110 and the hydroxyl functionality being between about 1.5 and about 3, preferably between about 1.9 and about 2.2.

The polyester polyol backbone should be predominantly made from adipic acid and linear aliphatic glycols, including but not limited to, ethylene glycol, 1,3 propanediol, 1,4 butanediol and 1,6 hexanediol. In one embodiment, the polyester polyol is prepared from reacting a mixture, at least about 90% by weight of which is a combination of adipic acid and at least one linear diol. It is believed that small amounts of ether containing diols or branched diols may not significantly compromise the excellent strength of the foam, it is preferable to avoid having larger amounts of these compounds. As a non-limiting example, small or trace amounts of crosslinkers, diols or diacids that contain either groups, branching, cyclics, aromatics, halogens, etc., and like substances may be components of the foam, while not significantly affecting the strength and elongation characteristics.

The high strength foams of the present invention are prepared from reacting a polyester polyol with an organic polyisocyanate and blowing agent, among other materials or compounds. In one preferred embodiment, the high strength foams of the present invention are prepared from reacting a polyester polyol with toluene diisocyanate (TDI) as a reactive ingredient and use water as the primary blowing agent. However, the invention is not so limited and any combination of organic polyisocyanate and blowing agent can be used. Referring back to the preferred embodiment, the amount of TDI should be about stoichiometric such that the total number of isocyanate groups per unit mass should be within about 15% of the total amount of reactive hydroxyl, water and amine groups in the same mass.

The high strength foam of the current invention is also prepared with at least one catalyst to control the rate of reaction. In one embodiment, the catalyst may be any of a variety of catalysts, including tertiary amines. Preferred catalysts are tertiary amines, particularly alkylated morpholines and piperazines, trialkyl amines, triethylene diamine, and amines with an oxygen bonded to the beta carbon. Specific examples include ethyl morpholine, methyl morpholine, coco morpholine, methoxy morpholine, dimorpholino diethylether, dimethyl piperazine, dimethyl cetylamine, dimethyl cyclohexylamine, dimethyl ethanolamine, bis(dimethylaminoethyl)ether, {ethanediylbis(oxy)} bis {dimethyl} ethaneamine. Nevertheless, other catalysts including, but not limited to, transition metal catalysts, or a combination of catalysts may be used to control the rate of the reaction.

Optionally, the foam of the present invention can include one or more interfacially active agents to emulsify the ingredients and stabilize the cellular structure before the polymer builds sufficient molecular weight to support itself. In one embodiment, the surfactant combination can contain separate ingredients for stabilization and emulsification, but it will preferably include at least some polyether-modified polysiloxane. Many commercial polyurethane foam surfactants do not provide enough stability to produce high strength foam, including those normally used to produce typical flexible polyester polyurethane foams. Although not required, in one preferred embodiment, the high strength foam of the current invention requires a highly stabilizing surfactant during processing, such as those designed to manufacture rigid polyurethane foams. Commercial examples of such a surfactant include, but are not limited to, Dabco DC193™ and DC5598™ from Air Products and Chemicals, Tegostab B8444 from Degussa-Goldschmidt Chemicals, Niax L-6980™ from GE-Bayer Silicones, and Silbyk 9200™ and TP-3806™ from Byk-Chemie.

Other optional ingredients can be included in processing the foam of the current invention to impart specific performance properties. These can include, but are not limited to, colorants, flame-retardants, fungicides, plasticizers, stabilizers, crosslinkers, antistatic agents, fillers, pigments, bactericides, antioxidants, and perfumes. Examples of stabilizers and/or crosslinkers include but are not limited to: diethanolamine, diethylene glycol, ethylene glycol, 1,4-butandiol and mixtures thereof. Examples of flame-retardants include but are not limited to: melamine, zinc borate, aluminum trihydrate, tris(chloropropyl)-phosphate, pentabromodiphenyl oxide and mixtures thereof. Examples of antistatic agents include but are not limited to: quaternary ammonium salts, alkali metal thiocyanates, transition metal salts, metal salts of fluoroalkyl sulfonic acids, and neoalkoxy, zirconate organometallics and mixtures thereof. Examples of fillers include but are not limited to: calcium carbonate, barium sulfate, clay, talc and mixtures thereof. Examples of suitable antioxidants include but are not limited to: BHT, alkylated diphenylamine, mixtures of alkylated and arylated diphenylamines, and mixtures thereof.

Processes known to those skilled in the art of producing polyurethane foam can be used in practicing the present invention. In on embodiment, when preparing a polyurethane foam in accordance with the present invention, the organic polyisocyanate is contacted, under foam forming conditions, with the polyester polyol in the presence of water and any other additives used. In practicing the present process, metering or dispensing equipment can be either of the low or high pressure variety; mixing can be by mechanical or by high pressure impingement; and product fabrication can be accomplished by a continuous process, i.e., slabstock, or via lamination, batch block, or a discontinuous process. In one preferred embodiment, the foam of the current invention is prepared using a continuous slabstock foam process.

The following examples illustrate preferred embodiments of high strength polyurethane foams and the polyester polyols that are the main ingredient.

### EXAMPLE 1

A three component polyester polyol (Polyol A) was made from about 2810 grams of Adipic acid, about 921 grams of 1,4 butanediol and about 768 grams of ethylene glycol. These components were reacted at about 200-220° C. for about 11 hours. The final polyester had a hydroxyl value of about 56.27, hydroxyl finctionality of about 2.0 and a number average molecular weight of about 1994.

### EXAMPLE 2

A four component polyester polyol (Polyol B) was made from about 2745 grams of Adipic acid, about 706 grams of 1,4 butanediol and about 706 grams of ethylene glycol and about 353 grams of 1,6 hexanediol. These components were reacted at about 200-220° C. for about 15 hours. The resulting polyester polyol had a hydroxyl value of about 51.8, hydroxyl functionality of about 2.0 and a number average molecular weight of about 2166.

### EXAMPLE 3

A four component polyester polyol (Polyol C) was made from about 2851 grams of Adipic acid, about 674 grams of 1,4 butanediol and about 674 grams of ethylene glycol and about 337 grams of 1,3 propanediol. These components were reacted at about 200-220° C. for about 11 hours. The resulting polyester polyol had a hydroxyl value of about 51.1, hydroxyl functionality of about 2.0 and a number average molecular weight of about 2196.

Table of Foam Ingredients

| Ingredient | Code | Function | Manufacturer |
|---|---|---|---|
| Polyester polyols A, B, and C | | Reactant | Inolex |
| | | | Chemical |
| Water | | Reactant | Inolex |
| | | | Chemical |
| Tolylene 2,4 diisocyanate tech | TDI-80 | Reactant | Aldrich |
| 80% | | | Chemical |
| Jeffcat E-40: | E-40 | Catalyst | Huntsman |
| {ethane-diylbis(oxy)}bis{di- | | | |
| methyl}ethaneamine | | | |
| 4-ethyl morpholine | NEM | Catalyst | Aldrich |
| | | | Chemical |
| Tegostab B8444: polyether | B8444 | Surfactant | Degussa- |
| modified polysiloxane | | | Goldschmidt |

The foams listed below were made by combining the ingredients in the stated ratios. TDI and polyester polyol were premixed at slow speed for about 20 seconds. Immediately thereafter, the catalyst, water and surfactant were added. Then the components were mixed at about 2500 rpm for about 6-7 seconds and poured into a rectangular box. The foam was allowed to react at room temperature, and within about 3 minutes, all had reached full rise height. This technique is typical for bench scale simulation of the commercial foaming process. It is understood that the mechanical process of combining and mixing the ingredients is not part of the invention and only serves to produce specimens for further testing.

Formulation Examples of High Strength Polyurethane Foam

| Foam | | Parts by weight | | | | | | Foam |
|---|---|---|---|---|---|---|---|---|
| ID | Polyol | Polyol | Water | TDI-80 | E-40 | NEM | B8444 | quality |
| F-1 | A | 100 | 3.2 | 37.6 | 0.3 | 1.0 | 1.2 | Uniform |
| F-2 | B | 100 | 3.0 | 33.4 | 0.3 | 1.0 | 1.2 | Uniform |
| F-3 | A | 100 | 3.0 | 37.1 | 0.3 | 1.0 | 1.2 | Uniform |
| F-4 | B | 100 | 3.0 | 40.8 | 0.3 | 1.0 | 1.2 | Uniform |
| F-5 | C | 100 | 3.0 | 37.1 | 0.3 | 1.0 | 1.2 | Uniform |
| F-6 | A | 100 | 3.0 | 33.4 | 0.3 | 1.0 | 1.2 | Uniform |
| F-7 | A | 100 | 3.2 | 37.1 | 0.3 | 1.0 | 1.2 | Uniform |
| F-8 | B | 100 | 3.0 | 37.1 | 0.3 | 1.0 | 1.2 | Uniform |
| F-9 | A | 100 | 3.0 | 40.8 | 0.3 | 1.0 | 1.2 | Uniform |
| F-10 | C | 100 | 3.0 | 33.4 | 0.3 | 1.0 | 1.2 | Uniform |
| F-11 | C | 100 | 3.0 | 40.8 | 0.3 | 1.0 | 1.2 | Uniform |
| F-12 | A | 100 | 3.0 | 37.6 | 0.4 | — | 1.0 | Uniform |
| F-13 | A | 100 | 3.0 | 37.6 | 0.3 | 0.5 | 1.2 | Uniform |

All foams were allowed to cure for at least a week before testing final mechanical properties. The data is listed in the following table with unit conversions described previously.

Physical properties of high strength foams

| | | Tensile | Grip | Horizontal | Cell |
|---|---|---|---|---|---|
| | Density | Strength | Elongation | Tear Strength | size |
| Sample | (pcf) | (psi) | (%) | (pli) | (cm⁻¹) |
| F-1 | 2.2 | 44 | 410 | 8.6 | 12 |
| F-2 | 2.4 | 42 | 420 | 5.2 | 9 |
| F-3 | 2.2 | 48 | 420 | 8.1 | 12 |
| F-4 | 2.1 | 37 | 290 | 7.3 | 10 |
| F-5 | 2.2 | 47 | 410 | 8.5 | 12 |
| F-6 | 2.4 | 50 | 590 | 5.2 | 12 |
| F-7 | 2.1 | 49 | 430 | 5.5 | 11 |
| F-8 | 2.2 | 44 | 390 | 8.3 | 10 |
| F-9 | 2.0 | 46 | 350 | 4.9 | 12 |
| F-10 | 2.4 | 46 | 590 | 5.9 | 12 |
| F-11 | 2.1 | 42 | 320 | 4.9 | 12 |

The results in the table above show that low density, high strength polyurethane foam can be produced with this invention. While these examples demonstrate the capability of this technology, they are not meant to limit the scope of the invention.

Whereas the present invention has been described in relation to the accompanying drawings, it should be understood that other and further modifications, apart from those shown or suggested herein, may be made within the spirit and scope of the present invention. It is also intended that all matter contained in the foregoing description or shown in the accompanying drawings shall be interpreted as illustrative rather than limiting.

What is claimed is:

1. A low density, high strength polyurethane foam prepared by a process comprising reacting, under foam forming conditions:
a polyester polyol having a number average molecular weight of about 1000 and about 4000;
an organic polyisocyanate;
a blowing agent; and
at least one catalyst.

2. The foam of claim 1, wherein the polyester polyol has an equivalent weight of between about 500 and about 2000.

3. The foam of claim 2, wherein the polyester polyol has a hydroxyl functionality of between about 2 and about 3 and a hydroxyl value between about 30 and about 110 mg KOH/g.

4. The foam of claim 1, wherein the polyester polyol is prepared from reacting a mixture, at least about 90% by weight of which is a combination of adipic acid and at least one linear diol.

5. The foam of claim 4, wherein the at least one linear diol is selected from the group consisting of ethylene glycol, 1,3 propanediol, 1,4 butanediol, 1,6 hexanediol and mixtures thereof.

6. The foam of claim 1, wherein the organic polyisocyanate is toluene diisocyanate.

7. The foam of claim 1, wherein the blowing agent comprises water.

8. The foam of claim 7, wherein the water is present in an amount between about 2 and about 5 parts per hundred polyol by weight.

9. The foam of claim 1, wherein the organic polyisocyanate is toluene diisocyanate, wherein the blowing agent comprises water, and wherein the toluene diisocyanate is added in stoichiometric amounts relative to the polyester polyol and the water.

10. The foam of claim 1, wherein the catalyst comprises a tertiary amine.

11. The foam of claim 1, wherein the catalyst is selected from a group consisting of alkylated morpholines and piperazines, trialkyl amines, triethylene diamine, ethyl morpholine, methyl morpholine, coco morpholine, methoxy morpholine, dimorpholino diethylether, dimethyl piperazine, dimethyl cetylamine, dimethyl cyclohexylamine, dimethyl ethanolamine, bis(dimethylaminoethyl)ether, {ethanediylbis(oxy)} bis {dimethyl} ethaneamine, amines with an oxygen bonded to the beta carbon, and mixtures thereof.

12. The foam of claim 1, wherein the catalyst is used in total between about 0.3 and about 3 parts per hundred polyol by weight to increase the rate of reaction such that the foam is fully expanded in less than about 5 minutes.

13. The foam of claim 1, further comprising reacting a foam stabilizer, wherein the foam stabilizer comprises a water-soluble or dispersible liquid with a density between about 1.0 and about 1.15 g/cm³ that contains a polyether modified polysiloxane and is used at between about 0.3 and about 3 parts per hundred polyol by weight.

14. The foam of claim 1, wherein the foam has a density of about 1 to about 4 pounds per cubic foot.

15. The foam of claim 1, wherein the foam produced has a tensile strength of at least about 30 pounds per square inch.

16. The foam of claim 1, wherein the foam has a tensile strength of between about 35 and about 50 pounds per square inch.

17. The foam of claim 1, wherein the foam has a tear strength of at least about 5 pounds per linear inch.

18. The foam of claim 1, wherein the foam has a tear strength of between about 5 to about 9 pounds per linear inch.

19. The foam of claim 1, wherein the foam is capable of elongating to at least about 300%.

20. The foam of claim 1, wherein the foam is capable of elongating to at least about 350%.

21. The foam of claim 1, wherein the foam has a density of about 1 to about 4 pounds per cubic foot, has a tensile strength between about 35 and about 50 pounds per square inch, has a tear strength between about 5 to about 9 pounds per linear inch and is capable of elongating to at least about 300%.

22. The foam of claim 1, wherein the foam is prepared using a continuous slabstock foam process.

23. The foam of claim 1, further comprising a highly stabilizing surfactant.

24. A low density, high strength polyurethane foam prepared by a process comprising reacting, under foam forming conditions:
A polyester polyol having a number average molecular weight of about 1000 and about 4000, having an equivalent weight between about 500 and about 2000, having a hydroxyl functionality of between about 2 and about 3 and a hydroxyl value between about 30 and about 110 mg KOH/g, wherein the polyester polyol is prepared from reacting a mixture, at least about 90% by weight of which is a combination of adipic acid and at least one linear diol;
an organic polyisocyanate;
a surfactant;
a blowing agent; and
at least one catalyst, wherein the foam has a density of about 1 to about 4 pounds per cubic foot, has a tensile strength between about 35 and about 50 pounds per square inch, has a tear strength between about 5 to about 9 pounds per linear inch and is capable of elongation to at least about 300%.

25. A method for preparing low density, high strength polyurethane foam comprising the step of reacting:
at least one polyester polyol having a number average molecular weight of about 1000 and about 4000, having a hydroxyl functionality of between about 2 and about 3 and a hydroxyl value between about 30 and about 110 mg KOH/g;
an organic polyisocyanate;
a blowing agent; and
at least one catalyst.

26. The method of claim 25, wherein the polyester polyol has an equivalent weight of between about 500 and about 2000.

27. The method of claim 25, wherein the polyester polyol is prepared from reacting a mixture, at least about 90% by weight of which is a combination of adipic acid and at least one linear diol.

28. The method of claim 25, wherein the organic polyisocyanate is toluene diisocyanate.

29. The method of claim 25, wherein the blowing agent is water.

30. The method of claim 25, wherein the catalyst comprises a tertiary amine.

31. The method of claim 25, wherein foam has a density of about 1 to about 4 pounds per cubic foot, has a tensile strength between about 35 and about 50 pounds per square inch, has a tear strength between about 5 to about 9 pounds per linear inch and is capable of elongation to at least about 300%.
